(19) United States
(12) Patent Application Publication
(10) Pub. No.: US 2025/0392556 A1
(43) Pub. Date: Dec. 25, 2025

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventors: Koji TSUKAMOTO, Tokyo (JP); Yoshihisa IJIRI, Tokyo (JP); Hiromu YAMAWAKI, Tokyo (JP); Toshinori MIYOSHI, Tokyo (JP); Takahiro ISHIKAWA, Tokyo (JP)

(21) Appl. No.: 19/057,482

(22) Filed: Feb. 19, 2025

(30) Foreign Application Priority Data
Jun. 20, 2024 (JP) 2024-099780

(51) Int. Cl. H04L 51/02; H04L 51/04; H04L 51/216

(52) U.S. Cl. CPC H04L 51/02; H04L 51/04; H04L 51/216

(57) ABSTRACT

An information processing apparatus includes a receiver, an identification unit, a determination unit, a parameter value acquisition unit, a service information acquisition unit, and a provision unit. The identification unit identifies the type of service and values of one or more parameters among a plurality of parameters used for providing the service of the type based on input information received by the receiver. The determination unit determines an unidentified parameter, which is a parameter having an unidentified value, among a plurality of parameters. The parameter value acquisition unit acquires the value of the unidentified parameter determined by the determination unit. The service information acquisition unit acquires information on service based on the values of the plurality of parameters including the values of one or more parameters and the value of the unidentified parameter. The provision unit provides information on service acquired by the service information acquisition unit to a user.

### CROSS-REFERENCE TO RELATED APPLICATIONS

The present application claims priority to and incorporates by reference the entire contents of Japanese Patent Application No. 2024-099780 filed in Japan on Jun. 20, 2024.

### BACKGROUND OF THE INVENTION

### 1. Field of the Invention

The present invention relates to an information processing apparatus, an information processing method, and an information processing program.

### 2. Description of the Related Art

There has been known service for users to exchange messages in a conversation format. For example, Japanese Laid-open Patent Publication No. 2022-180282 proposes a technique of receiving an input message input by a user through utterance, inputting information including the input message to generative AI such as a language model, and causing the generative AI to generate a response message.

Unfortunately, the above-described conventional technique does not disclose a technique of acquiring information for enhancing the accuracy of response contents corresponding to input information from a user. There is room for improvement in appropriately acquiring information.

### SUMMARY OF THE INVENTION

An information processing apparatus according to the present application includes a receiver, an identification unit, a determination unit, a parameter value acquisition unit, a service information acquisition unit, and a provision unit. The receiver receives input information including information on service from a user. The identification unit identifies the type of service and values of one or more parameters among a plurality of parameters used for providing the service of the type based on input information received by the receiver. The determination unit determines an unidentified parameter, which is a parameter having an unidentified value, among a plurality of parameters. The parameter value acquisition unit acquires the value of the unidentified parameter determined by the determination unit. The service information acquisition unit acquires information on service based on the values of the plurality of parameters including the values of one or more parameters and the value of the unidentified parameter. The provision unit provides information on service acquired by the service information acquisition unit to a user.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 illustrates an example of information processing according to an embodiment;

FIG. 2 illustrates an example of a configuration of an information processing system according to the embodiment;

FIG. 3 illustrates an example of a configuration of an information processing terminal according to the embodiment;

FIG. 4 illustrates an example of a screen of a chat room including information on service displayed on a display by a processor of the information processing terminal according to the embodiment;

FIG. 5 is a flowchart illustrating an example of the information processing performed by the processor of the information processing terminal according to the embodiment; and

FIG. 6 is a hardware configuration diagram illustrating an example of a computer that implements the function of the information processing terminal according to the embodiment.

### DETAILED DESCRIPTION OF THE PREFERRED EMBODIMENTS

An embodiment for carrying out an information processing apparatus, an information processing method, and an information processing program according to the present application (hereinafter, referred to as “embodiment”) will be described in detail below with reference to the drawings. Note that the information processing apparatus, the information processing method, and the information processing program according to the present application are not limited by the embodiment. Furthermore, the embodiment can be appropriately combined within a range in which processing contents do not contradict each other. Furthermore, in the following embodiment, the same parts are denoted by the same reference signs, and redundant description will be omitted.

### 1. EXAMPLE OF INFORMATION PROCESSING

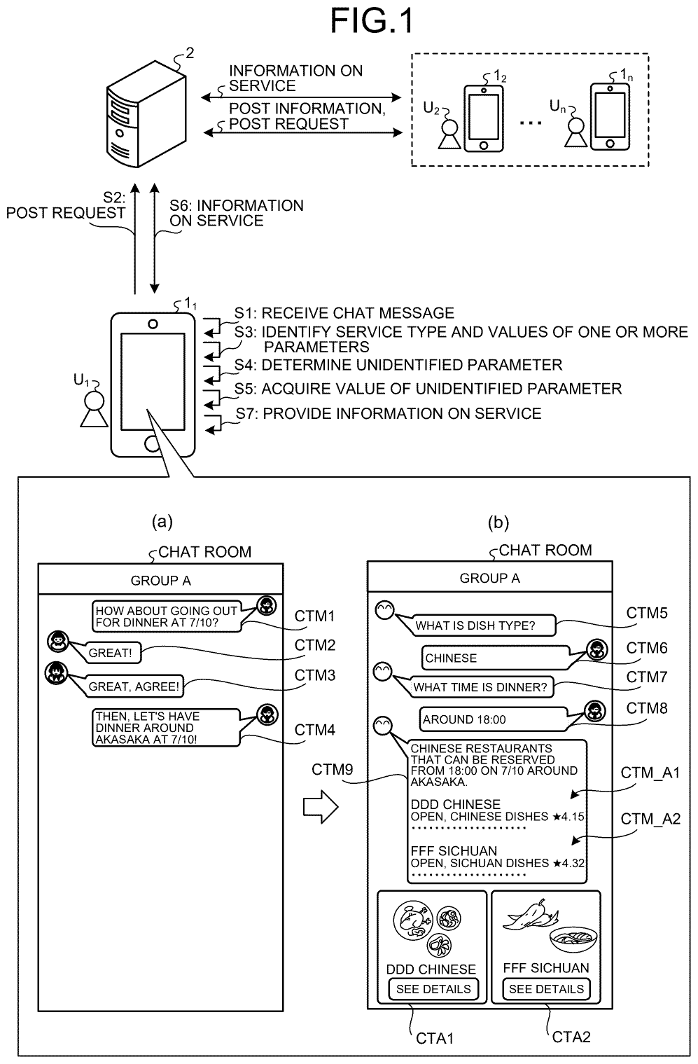

FIG. 1 illustrates an example of information processing according to the embodiment. In the embodiment, an information processing terminal executes the information processing method.

As illustrated in FIG. 1, information processing terminals 1₁, 1₂, . . . , and 1ₙ are communicably connected to a service providing device 2, and transmit and receive information to and from the service providing device 2. Here, n is an integer of two or more. The information processing terminals 1₁, 1₂, . . . , and 1ₙ are, for example, smartphones, tablets, and mobile personal computers (PCs).

Each of the information processing terminals 1₁, 1₂, . . . , and 1ₙ is used by a corresponding user among users U₁, U₂, . . . , and Uₙ. For example, the user U₁ uses the information processing terminal 1₁. The user U₂ uses the information processing terminal 1₂. The user Uₙ uses the information processing terminal 1ₙ. Hereinafter, when not individually distinguished, each of the information processing terminals 1₁, 1₂, . . . , and 1ₙ may be referred to as an information processing terminal 1. When not individually distinguished, each of the users U₁, U₂, . . . , and Uₙ may be referred to as a user U.

The service providing device 2 provides various types of service to the users U₁, U₂, . . . , and Uₙ of the information processing terminals 1₁, 1₂, . . . , and 1ₙ. The service providing device 2 provides online service such as chat service, various types of search service, various types of reservation service, advertisement distribution service, map information providing service, and e-commerce service.

The service providing device 2 provides, for example, an application programming interface (API). The information processing terminal 1 can transmit and receive various types of information in various types of online service via the API provided by the service providing device 2.

An instant messenger application for chatting (hereinafter, may be referred to as chat app) is installed in the information processing terminal 1. The chat app enables transmission and reception of messages in a one-to-one chat, transmission and reception of messages in a group chat, and transmission and reception of messages in a one-to-many chat. The information processing terminal 1 is an example of an information processing apparatus.

The user U can start the chat app by operating the information processing terminal 1, and receive provision of various types of service provided by the service providing device 2 by using the chat app. Although processing in the information processing terminal 1₁ will be described below, the information processing terminals 1₂, . . . , and 1ₙ other than the information processing terminal 1₁ can also perform similar processing.

When the user U₁ operates the information processing terminal 1₁ and starts the chat app, a chat app screen, which is a screen of a chat app, is displayed on the information processing terminal 1₁. When the user U₁ operates the information processing terminal 1₁ and selects an individual or a group as a destination of a chat message, a chat room of a one-to-one chat or a chat room of a group chat is displayed on the chat app screen of the information processing terminal 1₁.

The information processing terminal 1₁ receives, as input information, the chat message input by the user U₁ in the chat room (Step S1). The chat message received by the information processing terminal 1₁ is to be sent to the individual or the group serving as a destination. The information processing terminal 1₁ displays the chat message input by the user U₁ in the chat room.

The chat message input by the user U₁ may include a message including information on service from the user U₁. In this case, the information processing terminal 1₁ receives input information including information on service from the user U₁. Although the information on service relates to service provided by the service providing device 2, the information on service may relate to service provided by a service providing device other than the service providing device 2.

When receiving, as input information, the chat message input by the user U₁ in the chat room, the information processing terminal 1₁ transmits a post request including the received chat message to the service providing device 2 (Step S2). When receiving the post request, the service providing device 2 transmits and displays the received chat message to an information processing terminal 1 of another user U belonging to the same chat room.

The information processing terminal 1₁ identifies the type of service and values of one or more parameters among a plurality of parameters used for providing the service of the type based on the message received in Step S1 (Step S3).

Although the information processing terminal 1₁ executes the processing of Step S3 regardless of whether or not the message received in Step S1 includes the information on service, this example is not a limitation. For example, the information processing terminal 1₁ can execute the processing of Step S3 only when the message received in Step S1 includes a specific term or phrase, or can execute the processing of Step S3 only when the message received in Step S1 does not include the specific term or phrase.

Although examples of the type of service identified by the information processing terminal 1₁ include restaurant search service, hotel search service, restaurant reservation service, hotel reservation service, advertisement distribution service, map information providing service, and e-commerce service, these examples are not limitations. Hereinafter, the type of service may be referred to as a service type.

The plurality of parameters used for providing the service includes a necessary parameter and an additional parameter. The necessary parameter is necessary for providing the service. The additional parameter enhances the accuracy of providing the service.

Although, when the service type is the restaurant search service, examples of the necessary parameter include an area of a restaurant and the date, the time, and the number of people of scheduled dinner, and examples of the additional parameter include a dish type, a price range, a seat (terrace, table, and tatami mat), equipment (wheelchair and accompanying pet), evaluation, an allergy-provoking ingredient, a display order, and the upper limit of the number of acquisitions, these examples are not limitations.

Furthermore, although, when the service type is the hotel search service, examples of the necessary parameter include an area of a hotel and the date, the time, and the number of people of scheduled accommodations, and examples of the additional parameter include the number of rooms, the number of adults, the number of children, evaluation, a price range, equipment/service (wifi, Japanese-style room/Western-style room, double bed, single bed, and non-smoking/smoking), a display order, and the upper limit of the number of acquisitions, these examples are not limitations.

Furthermore, although, when the service type is the restaurant reservation service, examples of the necessary parameter include an area of a restaurant and the date, the time, and the number of people of scheduled dinner, and examples of the additional parameter include a dish type, a seat (terrace, table, and tatami mat), and an allergy-provoking ingredient, these examples are not limitations.

Furthermore, although, when the service type is the hotel reservation service, examples of the necessary parameter include an area of a hotel and the date, the time, and the number of people of scheduled accommodations, and examples of the additional parameter include the number of rooms, the number of adults, the number of children, a price range, the type of a room, and equipment/service (wifi, Japanese-style room/Western-style room, double bed, single bed, and non-smoking/smoking), these examples are not limitations.

In Step S3, for example, the information processing terminal 1₁ can identify values of a plurality of parameters used for providing the service, and identifies a value of a parameter having an identifiable value among the plurality of parameters from the input information received in Step S1 among the plurality of the parameters.

For example, when values of one or more necessary parameters can be identified based on the input information received in Step S1, the information processing terminal 1₁ identifies the values of one or more necessary parameters. Furthermore, when values of one or more additional parameters can be identified based on the input information received in Step S1, the information processing terminal 1₁ identifies the values of one or more necessary parameters.

For example, the information processing terminal 1₁ identifies the service type and the values of one or more parameters among the plurality of parameters used for providing the service of the service type based on the information on the service received in Step S1 by using generative artificial intelligence (AI).

The generative AI is, for example, text generative AI. The text generative AI is, for example, a large-scale language model in which learning is performed such that the next token is estimated from an input token string and output, and is, for example, a transformer-based model and a recurrent-neural-network (RNN)-based model.

Although examples of the transformer-based model include a generative pre-trained transformer (GPT), this example is not a limitation. Although, examples of the RNN-based model include a receptance weighted key value (RWKV), this example is not a limitation.

Note that the generative AI may be a language model in which learning (e.g., fine tuning) is performed specifically for generating answer information. Although the generative AI is disposed in an external information processing apparatus and the information processing terminal 1₁ uses the generative AI via an API, the generative AI may be disposed inside the information processing terminal 1₁.

The information processing terminal 1₁ can input information including the chat message input from the user U₁ and instruction information to the generative AI, and output the service type and the values of one or more parameters from the generative AI. The instruction information is used to instruct the generative AI to identify the service type and the values of one or more parameters used for providing the service of the type from the chat message input from the user U₁.

For example, the instruction information includes information of a character string “Please identify the type of service and values of parameters used for providing service of the type from the given message. Please identify the type of service from the following service type list, and identify the values of parameters from the following parameter list. Please output identification results in the following output format.”, a service type list, a parameter list, and information on an output format.

The service type list includes, for example, information in which a service type and information indicating the contents of the service are associated with each other for each service type. For example, the parameter list includes, for each service type, information in which a parameter and information indicating the contents of the parameter are associated with each other for each parameter. Note that the instruction information is not limited to the above-described examples, and is only required to be able to output the type of service and the values of parameters used for providing the service of the type from the message.

Furthermore, when the generative AI is a GPT provided by OpenAI, Inc., the generative AI can be caused to output the service type and the values of one or more parameters by using a function of function calling. In this case, the information input to the generative AI includes, for each service type, information indicating the definition of a service type and information indicating the definition of each parameter.

Furthermore, when the generative AI is finely tuned so as to output the type of service and the values of parameters used for providing the service of the type from the message, the input information input to the generative AI is not required to include the instruction information.

Furthermore, the information processing terminal 1₁ may have a configuration in which the type of service and the values of parameters used for providing the service of the type are identified from the message by a known slot filling technique not using the generative AI.

In an example in (a) of FIG. 1, the information processing terminal 1₁ displays chat messages CTM1 and CTM4 of the user U₁, a chat message CTM2 of the user U₂, and a chat message CTM3 of the user Uₘ. Furthermore, the chat group has a name of Group A. In the example in (a) of FIG. 1, Group A is a chat group of the users U₁, U₂, and Uₙ.

For example, the information processing terminal 1₁ identifies the restaurant search service as the type of service based on the chat message CTM4, and extracts a date “7/10” and an area “around Akasaka” as the values of one or more parameters among a plurality of parameters used for providing the restaurant search service.

Subsequently, the information processing terminal 1₁ determines an unidentified parameter, which is a parameter having an unidentified value in Step S3 among the plurality of parameters associated with the service type identified in Step S3 (Step S4). The processing of Step S4 is performed when the service type is identified in the processing of Step S3. When the service type is not identified in the processing of Step S3, the processing of Step S4 is not performed.

The information processing terminal 1₁ identifies a plurality of parameters associated with the service type identified in Step S3. The information processing terminal 1₁ stores the service type and the plurality of parameters in association with each other for each piece of service. Although including the necessary parameter and the additional parameter described above, the plurality of parameters sometimes does not include the additional parameter. The information processing terminal 1₁ identifies the plurality of parameters associated with the service type identified in Step S3 from the stored service type for each piece of service and the plurality of parameters for each service type.

For example, the information processing terminal 1₁ determines, as an unidentified parameter, a necessary parameter having an unidentified value among the plurality of parameters associated with the service type identified in Step S3. Furthermore, the information processing terminal 1₁ can also determine, as an unidentified parameter, an additional parameter having an unidentified value in addition to the necessary parameter having an unidentified value among the plurality of parameters.

Furthermore, when instruction information is set such that information on a parameter having an unidentified value is output from the generative AI, the information processing terminal 1₁ can also identify an unidentified parameter from the plurality of parameters associated with the service type identified in Step S3 based on the information output from the generative AI.

Subsequently, the information processing terminal 1₁ acquires the value of the unidentified parameter determined in Step S4 (Step S5). For example, the information processing terminal 1₁ can acquire the value of the unidentified parameter by inquiring of the user U₁.

For example, the information processing terminal 1₁ outputs an inquiry message for inquiring of the user U₁ the value of the unidentified parameter, and displays the inquiry message in the chat room displayed on the information processing terminal 1₁. The information processing terminal 1₁ stores, for each service type, information with which an inquiry message is associated for each parameter. The information processing terminal 1₁ identifies an inquiry message corresponding to the unidentified parameter determined in Step S4, and outputs the identified inquiry message.

Although, when the service type identified in Step S3 is the restaurant search service and the unidentified parameter determined in Step S4 is the scheduled time of dinner, the inquiry message is, for example, information of a character string “A restaurant that can be reserved is searched for. What time do you schedule dinner at the restaurant?”, this example is not a limitation.

Furthermore, the information processing terminal 1₁ can also generate an inquiry message by using the generative AI. For example, the information processing terminal 1₁ inputs, to the generative AI, information including instruction information for making an instruction to generate a sentence for inquiring the value of the unidentified parameter identified in Step S3, and causes the generative AI to generate an inquiry message.

When the service type identified in Step S3 is the restaurant search service and the unidentified parameter determined in Step S4 is the scheduled time of dinner, the instruction information to be input to the generative AI includes information of a character string “Please create a sentence for inquiring the scheduled time of dinner necessary for searching for a restaurant that can be reserved”, for example.

The information processing terminal 1₁ has, for each service type, information with which inquiry instruction information is associated for each parameter. The information processing terminal 1₁ identifies instruction information corresponding to the unidentified parameter determined in Step S4, inputs information including the identified instruction information to the generative AI, and causes the generative AI to generate an inquiry message.

The user U₁ operates the information processing terminal 1₁ to input the value of the unidentified parameter. The information processing terminal 1₁ acquires the value of the unidentified parameter input by the user U₁ in response to the inquiry message. The information processing terminal 1₁ displays the acquired value of the unidentified parameter in the chat room as a chat message of the user U₁.

Furthermore, the information processing terminal 1₁ can acquire the value of the unidentified parameter from a history of chat messages in the chat room instead of inquiring of the user U₁ the value of the unidentified parameter.

For example, the information processing terminal 1₁ inputs, to the generative AI, information including a history of one or more chat messages posted in the chat room before the message received in Step S1 and instruction information for making an instruction to extract the value of the unidentified parameter from the history, and causes the generative AI to extract the value of the unidentified parameter.

Although the instruction information in this case includes, for example, information of a character string “Estimate the value of XXX used in YYY from the given history of the messages”, this example is not a limitation. “YYY” included in the instruction information indicates a service type. “XXX” included in the instruction information indicates an unidentified parameter.

Furthermore, the information processing terminal 1₁ may have a term dictionary, which is a dictionary of terms corresponding to unidentified parameters. In this case, the information processing terminal 1₁ extracts a term by using a regular expression or the like from the history of one or more chat messages posted in the chat room before the message received in Step S1. When the above-described term dictionary includes the extracted term, the information processing terminal 1₁ acquires the term as a value of a specific parameter.

Furthermore, when the unidentified parameter is set as a parameter that can be estimated, the information processing terminal 1₁ can estimate the value of the unidentified parameter. The information processing terminal 1₁ acquires the value of the unidentified parameter by estimating the value of the unidentified parameter.

For example, the information processing terminal 1₁ can estimate the value of the unidentified parameter based on the attribute of the user U₁. The attribute of the user U is, for example, a demographic attribute and a psychographic attribute. The demographic attribute is a demographic attribute of the user U. The psychographic attribute is, for example, an attribute indicating the interest, the value, the lifestyle, the personality, and the like of the user U.

For example, the information processing terminal 1₁ inputs, to the generative AI, information including attribute information indicating the attribute of the user U₁ and instruction information for making an instruction to estimate the value of the unidentified parameter from the attribute information, and causes the generative AI to extract the value of the unidentified parameter.

Although the instruction information in this case includes, for example, information of a character string “Estimate the value of XXX used in YYY from the given attribute of the user”, this example is not a limitation. “YYY” included in the instruction information indicates a service type. “XXX” included in the instruction information indicates an unidentified parameter.

Furthermore, the information processing terminal 1₁ can store estimation information in which the attribute of the user U₁ is associated with the value of a parameter, and can estimate, as the value of the unidentified parameter, the value of a parameter associated with the same attribute as the attribute of the user U₁ in the estimation information.

Furthermore, the information processing terminal 1₁ can also estimate the value of the unidentified parameter based on a first conversation history, which is a history of conversations between the users U including the user U₁ in the chat room in which the message of the user U₁ received in Step S1 has been posted. For example, the information processing terminal 1₁ inputs, to the generative AI, information including the first conversation history and instruction information for making an instruction to estimate the value of the unidentified parameter from the first conversation history, and causes the generative AI to extract the value of the unidentified parameter.

Although the instruction information in this case includes, for example, information of a character string “Estimate the value of XXX used in YYY from the given conversation history”, this example is not a limitation. “YYY” included in the instruction information indicates a service type. “XXX” included in the instruction information indicates an unidentified parameter.

Furthermore, the information processing terminal 1₁ can also estimate the value of the unidentified parameter based on a second conversation history, which is a history of conversations between the plurality of users U including the user U in a chat room different from the chat room in which the message of the user U₁ received in Step S1 has been posted. For example, the information processing terminal 1₁ inputs, to the generative AI, information including the second conversation history and instruction information for making an instruction to estimate the value of the unidentified parameter from the second conversation history, and causes the generative AI to extract the value of the unidentified parameter.

Although the instruction information in this case includes, for example, information of a character string “Estimate the value of XXX used in YYY from the given conversation history”, this example is not a limitation. “YYY” included in the instruction information indicates a service type. “XXX” included in the instruction information indicates an unidentified parameter.

Furthermore, the information processing terminal 1₁ can also estimate the value of the unidentified parameter by using the generative AI as in the above-described processing based on two or more of the attribute of the user U₁, the first conversation history, and the second conversation history.

Note that examples of the above-described instruction information used to estimate the value of the unidentified parameter may include information in which one or more of an example of the attribute of the user U₁, an example of the first conversation history, and an example of the second conversation history are associated with the estimated value of the parameter. This can improve the accuracy of estimating the value of the unidentified parameter by using the generative AI.

Furthermore, the generative AI may be finely tuned so as to input information including one or more of the attribute of the user U₁, the first conversation history, and the second conversation history and output the value of the estimated unidentified parameter. In this case, the input information to the generative AI is not required to include the instruction information.

Subsequently, the information processing terminal 1₁ acquires information on service of the service type identified in Step S3 based on values of a plurality of parameters including the values of one or more parameters identified in Step S3 and the value of the unidentified parameter acquired in Step S5 (Step S6).

For example, when the service type identified in Step S3 is the restaurant search service, the information processing terminal 1₁ designates the restaurant search service, and transmits a search request including the values of an area of a restaurant and the date, the time, and the number of people of scheduled dinner to the service providing device 2 via an API of the service providing device 2.

The service providing device 2 searches for a plurality of restaurants in response to the search request, and acquires the search result as information on service of the service type identified in Step S3. Although the search result includes, for example, information such as the name, place, category of a dish to be provided, and an introductory essay of each restaurant which has been searched for, these examples are not limitations.

Furthermore, when the service type identified in Step S3 is the hotel search service, the information processing terminal 1₁ designates the hotel search service, and transmits a search request including the values of an area of a hotel and the date, the time, and the number of people of scheduled accommodations to the service providing device 2 via the API of the service providing device 2.

The service providing device 2 searches for a plurality of hotels in response to the search request, and provides the search result to the information processing terminal 1₁ as information on service of the service type identified in Step S3. Although the search result includes, for example, information such as the name, place, evaluation, and an introductory essay of each hotel which has been searched for, these examples are not limitations.

Furthermore, when the service type identified in Step S3 is the hotel reservation service, the information processing terminal 1₁ designates the hotel search service, and transmits a reservation request including the values of an area of a hotel and the date, the time, and the number of people of scheduled accommodations to the service providing device 2 via the API of the service providing device 2.

The service providing device 2 performs reservation processing in response to the reservation request, and provides the result of the reservation processing to the information processing terminal 1₁ as information on service of the service type identified in Step S3. The result of the reservation processing includes, for example, information of a character string “Reservation is completed.” and information indicating the reservation contents, these examples are not limitations.

Subsequently, the information processing terminal 1₁ provides the information on service acquired by the service providing device 2 in Step S6 to the user U₁ (Step S7). The information processing terminal 1₁ displays the information on service acquired in Step S6 as a chat message in the chat room in which the chat message received in Step S1 is displayed.

Furthermore, the information processing terminal 1₁ can display the information on service acquired in Step S6 in the chat room in a format different from that of the chat message, and display the information on service acquired in Step S6 in a pop-up window superimposed on the chat room.

In an example in (b) of FIG. 1, messages CTM5 and CTM7 for inquiring the value of the unidentified parameter and messages CTM6 and CTM8 including the value of the unidentified parameter are illustrated in the chat room of Group A in the information processing terminal 1₁. The messages CTM5 and CTM7 are information displayed by a parameter value acquisition unit 30. The messages CTM6 and CTM8 are information displayed by input from the user U.

In the example in (b) of FIG. 1, restaurant information CTA1, restaurant information CTA2, restaurant information CTM_A1, and restaurant information CTM_A2 are displayed in the chat room of Group A in the information processing terminal 1₁. The restaurant information CTA1 and the restaurant information CTM_A1 are information on DDD Chinese. The restaurant information CTA2 and the restaurant information CTM_A2 are information on FFF Sichuan.

The restaurant information CTM_A1 and the restaurant information CTM_A2 are information in a message format, and are included in a chat message CTM9. The restaurant information CTM_A1 and the restaurant information CTM_A2 are displayed in the same display mode as the display mode of the chat message on the screen of the group chat. The restaurant information CTA1 and the restaurant information CTA2 are information in a banner format including an image, text, and a link.

As described above, the information processing terminal 1 receives input information including information on service from the user U, and identifies the type of service and values of one or more parameters among a plurality of parameters used for providing the service of the type based on the input information. The information processing terminal 1 determines an unidentified parameter, which is a parameter having an unidentified value among the plurality of parameters, and acquires the value of the unidentified parameter.

Then, the information processing terminal 1 acquires information on service, and provides the information on service to the user U based on the values of a plurality of parameters including the identified values of one or more parameters and the acquired value of the unidentified parameter. This enables the information processing terminal 1 to appropriately acquire information for enhancing the accuracy of response contents corresponding to the input information from the user U.

The configuration and the like of an information processing system including the information processing terminals 1₁, 1₂, . . . , and 1ₘ, which perform such processing, and the service providing device 2 will be described in detail below.

### 2. CONFIGURATION OF INFORMATION PROCESSING SYSTEM

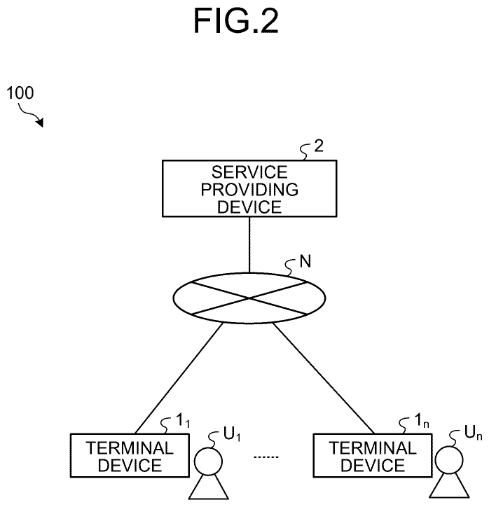

FIG. 2 illustrates an example of a configuration of an information processing system according to the embodiment. As illustrated in FIG. 2, an information processing system 100 according to the embodiment includes the information processing terminals 1₁, . . . , and 1ₙ and the service providing device 2.

The plurality of information processing terminals 1 are used by different users U. Although each of the information processing terminals 1 is, for example, a smartphone, a tablet PC, a laptop, a desktop PC, or the like, these examples are not limitations.

Each of the information processing terminal 1 and the service providing device 2 are communicably connected to each other by wire or wirelessly via a network N. Note that the information processing system 100 in FIG. 2 may include a plurality of service providing devices 2.

The network N includes, for example, a wide area network (WAN) and a mobile communication network of long term evolution (LTE), 4th generation (4G), a 5th generation (5G) mobile communication system, or the like on the Internet.

Each of the information processing terminals 1 can connect with the network N via short-range wireless communication such as a mobile communication network, Bluetooth (registered trademark), and a wireless local area network (LAN), and communicate with the service providing device 2.

### 3. CONFIGURATION OF INFORMATION PROCESSING TERMINAL 1

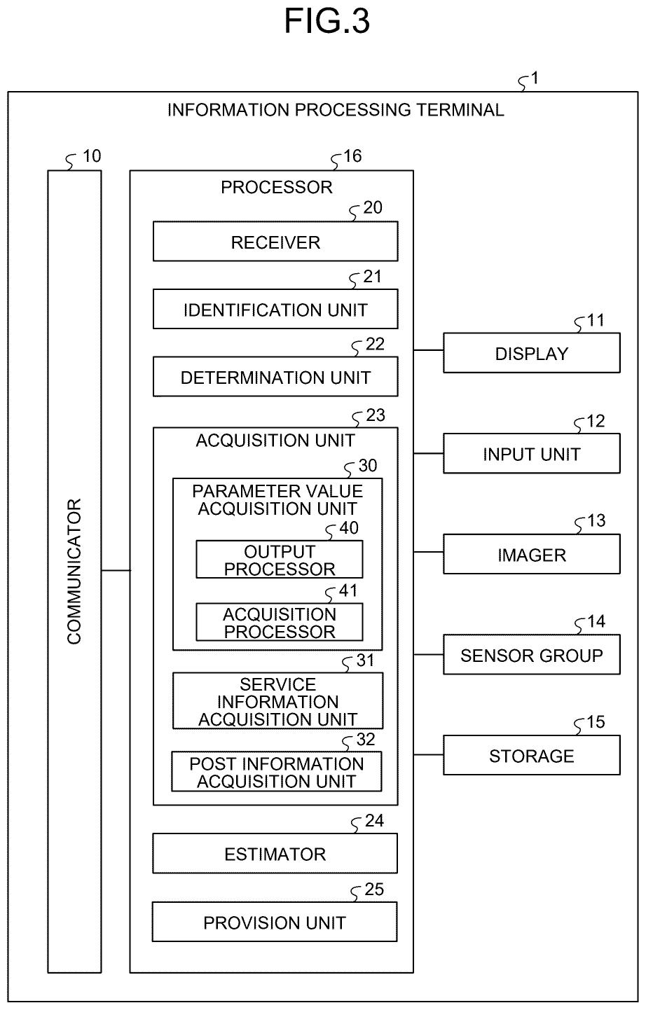

FIG. 3 illustrates an example of a configuration of the information processing terminal 1 according to the embodiment. As illustrated in FIG. 3, the information processing terminal 1 includes a communicator 10, a display 11, an input unit 12, an imager 13, a sensor group 14, a storage 15, and a processor 16. Note that, although not illustrated, the information processing terminal 1 also includes a speaker.

### 3.1. Communicator 10

The communicator 10 is implemented by, for example, a communication module or a network interface card (NIC). The communicator 10 is connected to the network N by wire or wirelessly, and transmits and receives information to and from the service providing device 2 via the network N.

### 3.2. Display 11

The display 11 is, for example, a liquid crystal display (LCD) or an organic electro luminescence (EL) display.

### 3.3. Input Unit 12

The input unit 12 includes, for example, a keyboard, a mouse, and a power button. The keyboard includes keys for inputting characters, numbers, and a space, the Enter key, and arrow keys. When the display 11 is a display compatible with a touch panel, the input unit 12 includes a touch panel.

### 3.4. Imager 13

The imager 13 is an image sensor (camera) that images a subject. For example, the imager 13 is a complementary metal oxide semiconductor (CMOS) image sensor or a charge-coupled device (CCD) image sensor. Note that the imager 13 is not limited to a built-in camera. The imager 13 may be an external camera such as a wireless camera and a web camera capable of communicating with the communicator 10.

### 3.5. Sensor Group 14

The sensor group 14 includes, for example, a positioning sensor, a microphone, an acceleration sensor, and a gyro sensor. The positioning sensor is a position sensor that detects the position of the information processing terminal 1. The microphone is a sensor that detects sound around the information processing terminal 1. The acceleration sensor detects the acceleration of the information processing terminal 1. The gyro sensor detects a posture such as inclination and rotation of the information processing terminal 1.

### 3.6. Storage 15

For example, the storage 15 is implemented by a semiconductor memory element, such as a random access memory (RAM) and a flash memory, or a storage device, such as a hard disk and an optical disk.

For example, the storage 15 stores information transmitted from the service providing device 2 and acquired by the processor 16 via the network N and the communicator 10 and detection information detected by the sensor group 14.

Furthermore, the storage 15 stores a service type and a plurality of parameters in association with each other for each piece of service. The plurality of parameters includes a necessary parameter and an additional parameter. The necessary parameter is necessary for providing service. The additional parameter enhances the accuracy of providing service.

Although, when the service type is the restaurant search service, examples of the necessary parameter include an area of a restaurant and the date, the time, and the number of people of scheduled dinner, and examples of the additional parameter include a dish type, a price range, a seat (terrace, table, and tatami mat), equipment (wheelchair and accompanying pet), evaluation, an allergy-provoking ingredient, a display order, and the upper limit of the number of acquisitions, these examples are not limitations.

Furthermore, although, when the service type is the hotel search service, examples of the necessary parameter include an area of a hotel and the date, the time, and the number of people of scheduled accommodations, and examples of the additional parameter include the number of rooms, the number of adults, the number of children, evaluation, a price range, equipment/service (wifi, Japanese-style room/Western-style room, double bed, single bed, and non-smoking/smoking), a display order, and the upper limit of the number of acquisitions, these examples are not limitations.

Furthermore, although, when the service type is the restaurant reservation service, examples of the necessary parameter include an area of a restaurant and the date, the time, and the number of people of scheduled dinner, and examples of the additional parameter include a dish type, a seat (terrace, table, and tatami mat), an allergy-provoking ingredient, a display order, and the upper limit of the number of acquisitions, these examples are not limitations.

Furthermore, although, when the service type is the hotel reservation service, examples of the necessary parameter include an area of a hotel and the date, the time, and the number of people of scheduled accommodations, and examples of the additional parameter include the number of rooms, the number of adults, the number of children, a price range, the type of a room, equipment/service (wifi, Japanese-style room/Western-style room, double bed, single bed, and non-smoking/smoking), a display order, and the upper limit of the number of acquisitions, these examples are not limitations.

Furthermore, the storage 15 stores setting information. The setting information includes acquisition availability information and estimation availability information. The acquisition availability information indicates the availability of acquiring each parameter for each service type. The estimation availability information indicates the availability of estimating each parameter for each service type. Furthermore, the setting information also includes attribute information indicating the attribute of the user U. Furthermore, the setting information also includes estimation use information related to another user U who has posted a chat message used to estimate a parameter.

### 3.7. Processor 16

The processor 16 is a controller, and is implemented by, for example, a central processing unit (CPU) or a micro processing unit (MPU) executing various programs stored in a storage device inside the information processing terminal 1 using a RAM as a work area.

A part or all of the processor 16 may be implemented by an integrated circuit such as an application specific integrated circuit (ASIC) and a field programmable gate array (FPGA). A chat app (example of information processing program) is installed in the processor 16 as a dedicated application program that operates on an operating system (OS). The processor 16 thereby functions as a functional unit including a receiver 20, an identification unit 21, a determination unit 22, an acquisition unit 23, an estimator 24, and a provision unit 25.

### 3.7.1. Receiver 20

The receiver 20 receives various requests and information. For example, the receiver 20 receives information input in response to an input operation of the user U as input information.

For example, the receiver 20 receives input information including information on service. For example, the receiver 20 receives input information including a message regarding service input by the user U in the chat room as information on service.

Note that the information received by the receiver 20 as the input information including information on service is not limited to the message regarding service input by the user U in the chat room, and may be input by the user U in an application other than the chat app, for example.

Furthermore, the receiver 20 receives an estimation availability setting request including estimation availability information indicating the availability of estimating a parameter. Although indicating the availability of estimating each parameter for each service type, the estimation availability information may indicate the availability of estimating parameters for each service type, or indicate the availability of estimating parameters for all service types. Furthermore, the receiver 20 receives an estimation use information setting request including the estimation use information. The estimation use information includes information on another user U who has posted a chat message used to estimate a parameter.

### 3.7.2. Identification Unit 21

The identification unit 21 performs various identifications. The identification unit 21 identifies the type of service and values of one or more parameters among a plurality of parameters used for providing the service of the type based on the input information (e.g., chat message) received by the receiver 20.

For example, when the type of service can be identified, the identification unit 21 identifies a value of a parameter having an identifiable value among the plurality of parameters used for providing the service of the type based on the input information received by the receiver 20.

For example, when values of one or more necessary parameters among the plurality of parameters used for providing the identified type of service and one or more additional parameters can be identified, the identification unit 21 identifies the values of one or more necessary parameters and one or more additional parameters.

Furthermore, even when the values of one or more necessary parameters cannot be identified, when one or more additional parameters can be identified, when one or more additional parameters can be identified, the identification unit 21 identifies one or more additional parameters.

The identification unit 21 identifies a service type and values of one or more parameters among a plurality of parameters used for providing the service of the service type based on the input information received by the receiver 20 by using, for example, the generative AI.

The generative AI is, for example, text generative AI. The text generative AI is, for example, a large-scale language model in which learning is performed such that the next token is estimated from an input token string and output, and is, for example, a transformer-based model and an RNN-based model. Although examples of the transformer-based model include a GPT, this example is not a limitation. Although examples of the RNN-based model include an RWKV, this example is not a limitation.

Note that the generative AI may be a language model in which learning (e.g., fine tuning) is performed specifically for generating answer information. Although the generative AI is disposed in an external information processing apparatus and the identification unit 21 uses the generative AI via an API, the generative AI may be disposed inside the information processing terminal 1.

For example, the identification unit 21 inputs information including input information and instruction information to the generative AI. The input information has been received by the receiver 20. The instruction information is used for making an instruction to identify the type of service and values of a plurality of parameters. The identification unit 21 causes the generative AI to identify the type of service and the values of one or more parameters.

For example, the instruction information includes information of a character string “Please identify the type of service and values of parameters used for providing service of the type from the next message. Please identify the type of service from the following service type list, and identify the values of parameters from the following parameter list. Please output identification results in the following output format.”, a service type list, a parameter list, and information on an output format.

The service type list includes, for example, information in which a service type and information indicating the contents of the service are associated with each other for each service type. For example, the parameter list includes, for each service type, information in which a parameter and information indicating the contents of the parameter are associated with each other for each parameter. Note that the instruction information is not limited to the above-described examples, and is only required to be able to output the type of service and the values of parameters used for providing the service of the type from the message.

Furthermore, when the generative AI is a GPT provided by OpenAI, Inc., the generative AI can be caused to output the service type and the values of one or more parameters by using a function of function calling. In this case, the information input to the generative AI includes, for each service type, information indicating the definition of a service type and information indicating the definition of each parameter.

Furthermore, when the generative AI is finely tuned so as to output the type of service and the values of parameters used for providing the service of the type from the message, the input information input to the generative AI is not required to include the instruction information.

Furthermore, the identification unit 21 may have a configuration in which the type of service and the values of parameters used for providing the service of the type are identified from the message by a known slot filling technique not using the generative AI.

### 3.7.3. Determination Unit 22

The determination unit 22 performs various determinations. The determination unit 22 determines an unidentified parameter, which is a parameter having an unidentified value, among a plurality of parameters associated with the service type identified by the identification unit 21.

The determination unit 22 identifies a plurality of parameters associated with the service type identified by the identification unit 21. The determination unit 22 stores the service type and the plurality of parameters in association with each other for each piece of service. The plurality of parameters includes a necessary parameter and an additional parameter as described above. The determination unit 22 identifies the plurality of parameters associated with the service type identified by the identification unit 21 from the stored service type for each piece of service and the plurality of parameters for each service type.

For example, the determination unit 22 determines, as an unidentified parameter, a necessary parameter having an unidentified value among a plurality of parameters associated with the service type identified by the identification unit 21. Furthermore, the determination unit 22 can also determine, as an unidentified parameter, an additional parameter having an unidentified value in addition to the necessary parameter having an unidentified value among the plurality of parameters.

Furthermore, when instruction information is set such that information on a parameter having an unidentified value is output from the generative AI, the determination unit 22 can also identify an unidentified parameter from the plurality of parameters associated with the service type identified by the identification unit 21 based on the information output from the generative AI.

### 3.7.4. Acquisition Unit 23

The acquisition unit 23 acquires various types of information. The acquisition unit 23 includes the parameter value acquisition unit 30, a service information acquisition unit 31, and a post information acquisition unit 32.

### 3.7.4.1. Parameter Value Acquisition Unit 30

The parameter value acquisition unit 30 acquires the value of the unidentified parameter determined by the determination unit 22. The parameter value acquisition unit 30 includes an output processor 40 and an acquisition processor 41. The output processor 40 outputs a message for inquiring of the user U the value of the unidentified parameter. The acquisition processor 41 acquires the value of the unidentified parameter input by the user U in response to the message output from the output processor 40.

### 3.7.4.1.1. Output Processor 40

The output processor 40 outputs, to the display 11, an inquiry message for inquiring of the user U the value of the unidentified parameter, and displays the inquiry message on the display 11.

For example, the output processor 40 adds the inquiry message for inquiring of the user U the value of the unidentified parameter to the chat room displayed on the display 11, and thereby displays the inquiry message on the display 11.

The output processor 40 stores, for each service type, information with which an inquiry message is associated for each parameter. The output processor 40 identifies an inquiry message corresponding to the unidentified parameter determined by the determination unit 22, and outputs the identified inquiry message to the display 11.

Although, when the service type identified by the identification unit 21 is the restaurant search service and the unidentified parameter determined by the determination unit 22 is the scheduled time of dinner, the inquiry message is, for example, information of a character string “A restaurant that can be reserved is searched for. What time do you schedule dinner at the restaurant?”, this example is not a limitation.

The output processor 40 outputs, to the display 11, the value of the unidentified parameter input by an operation of the input unit 12 from the user U in response to the above-described inquiry message, and displays the value of the unidentified parameter on the display 11. For example, the output processor 40 adds the value of the unidentified parameter to the chat room displayed on the display 11, and thereby displays the value of the unidentified parameter on the display 11.

### 3.7.4.1.2. Acquisition Processor 41

The acquisition processor 41 acquires the value of the unidentified parameter determined by the determination unit 22.

For example, the acquisition processor 41 acquires the value of the unidentified parameter input by the user U in response to the inquiry message output by the output processor 40.

Furthermore, the acquisition processor 41 can acquire the value of the unidentified parameter from a history of chat messages in the chat room instead of inquiring of the user U the value of the unidentified parameter.

For example, the acquisition processor 41 inputs, to the generative AI, information including a history of one or more chat messages posted in the chat room before the message received by the receiver 20 and instruction information for making an instruction to extract the value of the unidentified parameter from the history, and causes the generative AI to extract the value of the unidentified parameter.

Although the instruction information in this case includes, for example, information of a character string “Estimate the value of XXX used in YYY from the given history of the messages”, this example is not a limitation. “YYY” included in the instruction information indicates a service type. “XXX” included in the instruction information indicates an unidentified parameter.

Furthermore, the acquisition processor 41 may have a term dictionary, which is a dictionary of terms corresponding to unidentified parameters. In this case, the acquisition processor 41 extracts a term by using a regular expression or the like from the history of one or more chat messages posted in the chat room before the message received by the receiver 20. When the above-described term dictionary includes the extracted term, the acquisition processor 41 acquires the term as a value of a specific parameter.

Furthermore, when the unidentified parameter is set as a parameter that can be estimated or when the acquisition processor 41 does not acquire the value of the unidentified parameter, the acquisition processor 41 acquires the value of the unidentified parameter estimated by the estimator 24. The acquisition processor 41 acquires the value of the unidentified parameter estimated by the estimator 24 based on one or more of, for example, the attribute of the user U, the first conversation history, and the second conversation history.

### 3.7.4.2. Service Information Acquisition Unit 31

The service information acquisition unit 31 acquires information on service based on values of a plurality of parameters including values of one or more parameters and a value of an unidentified parameter.

For example, when the service type identified by the identification unit 21 is the restaurant search service, the service information acquisition unit 31 designates the restaurant search service, and transmits a search request including the values of an area of a restaurant and the date, the time, and the number of people of scheduled dinner to the service providing device 2 via an API of the service providing device 2.

The service providing device 2 searches for a plurality of restaurants in response to the search request, and acquires the search result as information on service of the service type identified by the identification unit 21. Although the search result includes, for example, information such as the name, place, category of a dish to be provided, and an introductory essay of each restaurant which has been searched for, these examples are not limitations.

Furthermore, when the service type identified by the identification unit 21 is the hotel reservation service, the service information acquisition unit 31 designates the hotel search service, and transmits a reservation request including the values of an area of a hotel and the date, the time, and the number of people of scheduled accommodations to the service providing device 2 via the API of the service providing device 2.

The service providing device 2 performs reservation processing in response to the reservation request, and acquires the result of the reservation processing as information on service of the service type identified by the identification unit 21. The result of the reservation processing includes, for example, information of a character string “Reservation is completed.” and information indicating the reservation contents, these examples are not limitations.

### 3.7.4.3. Post Information Acquisition Unit 32

The post information acquisition unit 32 acquires post information including a chat message of another user U provided from the service providing device 2, and displays the chat message of the other user U on the display 11 based on the acquired posted message.

### 3.7.5. Estimator 24

The estimator 24 performs various estimations. The estimator 24 estimates the value of the unidentified parameter determined by the determination unit 22.

Furthermore, when the unidentified parameter is set as a parameter that can be estimated, the estimator 24 estimates the value of the unidentified parameter. The information stored in the storage 15 includes estimation availability information indicating the availability of estimating each parameter for each service type. The estimator 24 determines whether or not the unidentified parameter is set as a parameter that can be estimated based on the estimation availability information. Note that the estimation availability information may indicate the availability of estimating parameters for each service type, or indicate the availability of estimating parameters for all service types.

Furthermore, when the information stored in the storage 15 does not include the estimation availability information, the estimator 24 can cause the provision unit 25 to output an inquiry message for inquiring whether estimation of the unidentified parameter is permitted (e.g., information of character string “Is estimation of a parameter of XXX permitted?”).

In this case, when the user U inputs a positive response (e.g., information of character string “Yes”) to the inquiry message by performing an operation to the input unit 12, the estimator 24 estimates the value of the unidentified parameter corresponding to the inquiry message. Note that the estimator 24 can cause the provision unit 25 to output the inquiry message also when the storage 15 stores the estimation availability information.

Furthermore, when the acquisition processor 41 does not acquire the value of the unidentified parameter, the estimator 24 estimates the value of the unidentified parameter. The value of the unidentified parameter not acquired by the acquisition processor 41 does not include the value of the unidentified parameter estimated by the estimator 24.

The case where the acquisition processor 41 does not acquire the value of the unidentified parameter includes, for example, a case where the acquisition processor 41 does not acquire the value of the unidentified parameter input by the user U in response to the inquiry message or a case where the acquisition processor 41 does not acquire the value of the unidentified parameter from the history of chat messages in the chat room.

The estimator 24 estimates the value of the unidentified parameter based on the attribute of the user U. For example, the estimator 24 inputs, to the generative AI, information including attribute information indicating the attribute of the user U and instruction information for making an instruction to estimate the value of the unidentified parameter from the attribute information, and causes the generative AI to extract the value of the unidentified parameter.

Although the instruction information in this case includes, for example, information of a character string “Estimate the value of XXX used in YYY from the given attribute of the user”, this example is not a limitation. “YYY” included in the instruction information indicates a service type. “XXX” included in the instruction information indicates an unidentified parameter.

Furthermore, the estimator 24 can store estimation information in which the attribute of the user U is associated with the value of a parameter, and can estimate, as the value of the unidentified parameter, the value of a parameter associated with the same attribute as the attribute of the user U of the information processing terminal 1 in the estimation information.

Furthermore, the estimator 24 estimates the value of the unidentified parameter based on the first conversation history, which is a conversation history in the chat room displayed on the display 11. For example, the estimator 24 inputs, to the generative AI, information including the first conversation history and instruction information for making an instruction to estimate the value of the unidentified parameter from the first conversation history, and causes the generative AI to extract the value of the unidentified parameter.

Although the instruction information in this case includes, for example, information of a character string “Estimate the value of XXX used in YYY from the given conversation history”, this example is not a limitation. “YYY” included in the instruction information indicates a service type. “XXX” included in the instruction information indicates an unidentified parameter.

Furthermore, the estimator 24 can treat, as the first conversation history, only a history of conversations with another user U preliminarily permitted to use a chat message among conversation histories in the chat room, and estimate the value of the unidentified parameter based on the first conversation history. Although the other user U preliminarily permitted to use a chat message is indicated in the estimation use information, this example is not a limitation.

Furthermore, the estimator 24 can also estimate the value of the unidentified parameter by using, as the first conversation history, a chat message of the user U in the chat room displayed on the display 11 and a chat message to the user U generated by the generative AI. In this case, the first conversation history does not include a chat message of the other user U in the chat room, so that the estimator 24 can easily narrow down the taste, intention, and the like of the user U from the past exchange of the user U in the chat room.

Furthermore, the estimator 24 can also estimate the value of the unidentified parameter by using, as the first conversation history, a related chat message posted in a predetermined period until a specific chat message is posted. For example, the specific chat message is received by the receiver 20, and used for the identification unit 21 to identify the type of service. For example, the related chat message is related to the type of service identified by the identification unit 21.

For example, the estimator 24 has a term list for each type of service. The estimator 24 determines, as a related chat message, a chat message including a term included in the term list corresponding to the type of service identified by the identification unit 21 among chat messages posted in the chat room in a predetermined period until the specific chat message is posted. Furthermore, the estimator 24 can also estimate the related chat message by using the generative AI.

Furthermore, the estimator 24 estimates the value of the unidentified parameter based on the second conversation history, which is a history of conversations between the user U and a plurality of users including the other user U in another chat room different from the chat room displayed on the display 11. For example, the estimator 24 inputs, to the generative AI, information including the second conversation history and instruction information for making an instruction to estimate the value of the unidentified parameter from the second conversation history, and causes the generative AI to extract the value of the unidentified parameter.

Although the instruction information in this case includes, for example, information of a character string “Estimate the value of XXX used in YYY from the given conversation history”, this example is not a limitation. “YYY” included in the instruction information indicates a service type. “XXX” included in the instruction information indicates an unidentified parameter.

Furthermore, the estimator 24 can treat, as the second conversation history, only a history of conversations with another user U preliminarily permitted to use a chat message among conversation histories in the other chat room, and estimate the value of the unidentified parameter based on the second conversation history. Although the other user U preliminarily permitted to use a chat message is indicated in the estimation use information, this example is not a limitation.

Furthermore, the estimator 24 can also estimate the value of the unidentified parameter by using, as the second conversation history, a chat message of the user U in the other chat room and a chat message to the user U generated by the generative AI. In this case, the second conversation history does not include a chat message of the other user U in the other chat room, so that the estimator 24 can easily narrow down the taste, intention, and the like of the user U from the past exchange of the user U in the other chat room.

Furthermore, the estimator 24 can also estimate the value of the unidentified parameter by using, as the second conversation history, another related chat message posted in the other chat room in a predetermined period until another specific chat message posted in the other chat room is posted. For example, the specific chat message is received by the receiver 20, and used for the identification unit 21 to identify the type of service. The specific chat message has been posted in the other chat room. For example, the other related chat message has been posted in the other chat room, and is related to the type of service identified by the identification unit 21.

For example, the estimator 24 has a term list for each type of service. The estimator 24 determines, as the other related chat message, a chat message including a term included in the term list corresponding to the type of service identified by the identification unit 21 among chat messages posted in the other chat room in a predetermined period until the specific chat message is posted. Furthermore, the estimator 24 can also estimate the other related chat message by using the generative AI.

Furthermore, the estimator 24 can also estimate the value of the unidentified parameter by using the generative AI as in the above-described processing based on two or more of the attribute of the user U, the first conversation history, and the second conversation history.

Note that examples of the above-described instruction information used to estimate the value of the unidentified parameter may include information in which one or more of an example of the attribute of the user U₁, an example of the first conversation history, and an example of the second conversation history are associated with the estimated value of the parameter. This can improve the accuracy of estimating the value of the unidentified parameter by using the generative AI.

Furthermore, the generative AI may be finely tuned so as to input information including one or more of the attribute of the user U, the first conversation history, and the second conversation history and output an estimated value of the unidentified parameter. In this case, the input information to the generative AI is not required to include the instruction information.

### 3.7.6. Provision Unit 25

The provision unit 25 performs various provisions. The provision unit 25 provides information on service acquired by the service information acquisition unit 31 to the user U.

The provision unit 25 provides the information on service acquired by the service information acquisition unit 31 to the user U by displaying the information on service acquired by the service information acquisition unit 31 as a chat message in the chat room in which the chat message received by the receiver 20 is displayed.

Furthermore, the provision unit 25 can provide the information on service acquired by the service information acquisition unit 31 to the user U by, for example, displaying the information on service acquired by the service information acquisition unit 31 in the chat room in a format different from that of the chat message or displaying the information on service acquired by the service information acquisition unit 31 in a pop-up window superimposed on the chat room.

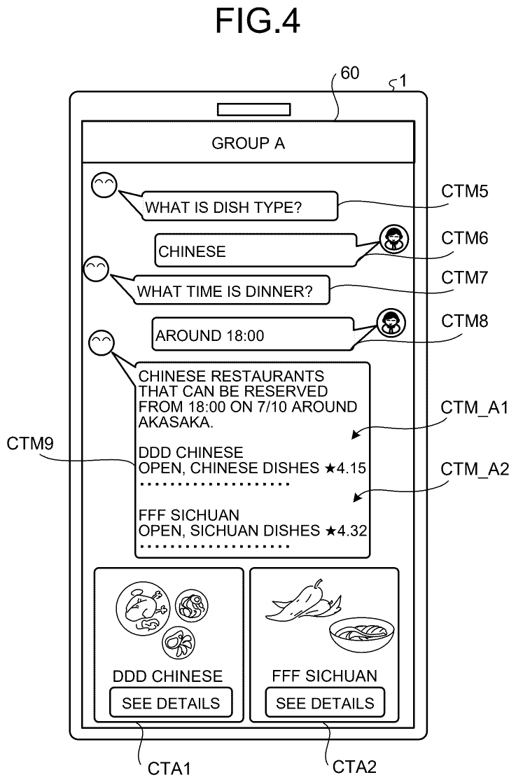

FIG. 4 illustrates an example of a screen of a chat room including information on service displayed on the display 11 by the processor 16 of the information processing terminal 1 according to the embodiment. A screen 60 of the chat room in FIG. 4 is a chat room screen of Group A.

In an example in FIG. 4, the messages CTM5 and CTM7 for inquiring the value of the unidentified parameter and the messages CTM6 and CTM8 including the value of the unidentified parameter are illustrated in the chat room of Group A in the information processing terminal 1₁. The messages CTM5 and CTM7 are information displayed by the parameter value acquisition unit 30. The messages CTM6 and CTM8 are information displayed by input from the user U.

In the example in FIG. 4, the restaurant information CTA1, the restaurant information CTA2, the restaurant information CTM_A1, and the restaurant information CTM_A2 are displayed in the chat room of Group A in the information processing terminal 1₁. The restaurant information CTA1 and the restaurant information CTM_A1 are information on DDD Chinese. The restaurant information CTA2 and the restaurant information CTM_A2 are information on FFF Sichuan.

The restaurant information CTM_A1 and the restaurant information CTM_A2 are information in a message format, and are included in the chat message CTM9. The restaurant information CTM_A1 and the restaurant information CTM_A2 are displayed in the same display mode as the display mode of the chat message on the screen of the group chat. The restaurant information CTA1 and the restaurant information CTA2 are information in a banner format including an image, text, and a link.

### 4. PROCESSING PROCEDURE

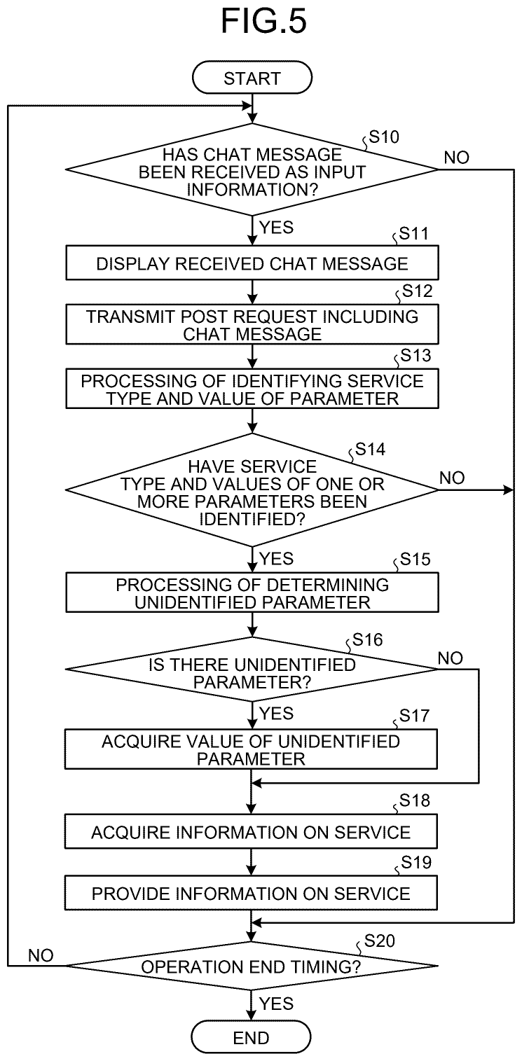

Next, a procedure of information processing performed by the processor 16 of the information processing terminal 1 according to the embodiment will be described. FIG. 5 is a flowchart illustrating an example of the information processing performed by the processor 16 of the information processing terminal 1 according to the embodiment.

As illustrated in FIG. 5, the processor 16 of the information processing terminal 1 determines whether or not a chat message has been received as input information (Step S10). When determining that a chat message has been received as input information (Step S10: Yes), the processor 16 displays the received chat message on the display 11 (Step S11), and transmits a post request including the received chat message to the service providing device 2 (Step S12).

Subsequently, the processor 16 performs processing of identifying a service type and a value of a parameter based on the received chat message (Step S13). The processor 16 determines whether or not the service type and values of one or more parameters have been successfully identified in the identification processing of Step S13 (Step S14).

When determining that the service type and the values of one or more parameters have been successfully identified in the identification processing of Step S13 (Step S14: Yes), the processor 16 performs determination processing of determining an unidentified parameter, which is a parameter having an unidentified value, among a plurality of parameters corresponding to the service type identified in Step S13 (Step S15).

The processor 16 determines whether or not the processor 16 has determined that there is an unidentified parameter in the determination processing of Step S15 (Step S16). When determining that there is an unidentified parameter (Step S16: Yes), the processor 16 acquires a value of the unidentified parameter (Step S17).

When the processing of Step S17 ends or when determining that there is not an unidentified parameter (Step S16: No), the processor 16 acquires information on service of the service type identified in Step S13 based on the values of the plurality of parameters (Step S18). Then, the processor 16 provides information on service acquired in Step S18 (Step S19).

When the processing of Step S19 ends, when determining that the chat message has not been received as input information (Step S10: No), or when determining that the service type and the values of one or more parameters have failed to be successfully identified in the identification processing of Step S13 (Step S14: No), the processor 16 determines whether or not operation end timing has come (Step S20). The processor 16 determines that the operation end timing has come, for example, when the power of the information processing terminal 1 is turned off.

When determining that the operation end timing has not come (Step S20: No), the processor 16 shifts the processing to Step S10. When determining that the operation end timing has come (Step S20: Yes), the processor 16 ends the processing in FIG. 5.

### 5. VARIATIONS

A part or all of the functions of the information processing terminal 1 described above may be implemented by the service providing device 2. For example, the service providing device 2 may include some or all of the receiver 20, the identification unit 21, the determination unit 22, the acquisition unit 23, the estimator 24, and the provision unit 25 described above instead of the information processing terminal 1.

Although, in the above-described example, the generative AI has been described as being text generative AI, this example is not a limitation. The generative AI may be, for example, multimodal generative AI. For example, the multimodal generative AI can generate text and an image from text, an image, and the like.

Furthermore, for example, the parameter value acquisition unit 30 can individually output a message for inquiring of the user U the value of the unidentified parameter only to the user U who has not acquired the value of the unidentified parameter.

Furthermore, the estimator 24 can also acquire information for estimating the value of the unidentified parameter from another application or an external server in cooperation with the other application or the external server. The other application has been installed in the information processing terminal 1, and is different from the chat app.

In this case, the estimator 24 estimates the value of the unidentified parameter by using information acquired from the other application instead of or in addition to the above-described information. Although the other application includes a schedule application, a map application, and a reservation application, these examples are not limitations. Furthermore, although examples of the external server include a web search server, this example is not a limitation.

For example, the estimator 24 estimates the value of the unidentified parameter from the other application based on the schedule of the user U, the position of the user U, the history of movements of the User U, the contents of a hotel and a restaurant reserved by the user U, and a search query input by the user U. Although a method of the estimator 24 estimating the value of the unidentified parameter includes an estimation method using the generative AI as described above and a rule-based estimation method, these examples are not limitations.

### 6. HARDWARE CONFIGURATION

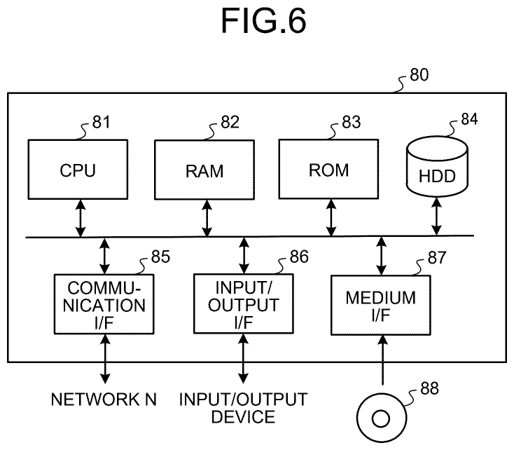

The information processing terminal 1 according to the above-described embodiment is implemented by a computer 80 having a configuration as illustrated in FIG. 6, for example. FIG. 6 is a hardware configuration diagram illustrating an example of the computer 80 that implements the function of the information processing terminal 1 according to the embodiment. The computer 80 includes a CPU 81, a RAM 82, a read only memory (ROM) 83, a hard disk drive (HDD) 84, a communication interface (I/F) 85, an input/output interface (I/F) 86, and a medium interface (I/F) 87.

The CPU 81 operates based on a program stored in the ROM 83 or the HDD 84, and controls each unit. The ROM 83 stores a boot program executed by the CPU 81 at the start of the computer 80, a program depending on the hardware of the computer 80, and the like.

The HDD 84 stores a program executed by the CPU 81, data used by the program, and the like. The communication interface 85 receives data from another device and sends the data to the CPU 81 via the network N (see FIG. 2), and transmits data generated by the CPU 81 to the other device via the network N.

The CPU 81 controls output devices, such as a display and a printer, and input devices, such as a keyboard and a mouse, via the input/output interface 86. The CPU 81 acquires data from an input device via the input/output interface 86. Furthermore, the CPU 81 outputs generated data to an output device via the input/output interface 86.

The medium interface 87 reads a program or data stored in a recording medium 88, and provides the program or the data to the CPU 81 via the RAM 82. The CPU 81 loads the program from the recording medium 88 onto the RAM 82 via the medium interface 87, and executes the loaded program. Examples of the recording medium 88 include an optical recording medium, such as a digital versatile disc (DVD) and a phase change rewritable disk (PD), a magneto-optical recording medium such as a magneto-optical disk (MO), a tape medium, a magnetic recording medium, and a semiconductor memory.

For example, when the computer 80 functions as the information processing terminal 1 according to the embodiment, the CPU 81 of the computer 80 implements the function of the processor 16 by executing the program loaded onto the RAM 82. Furthermore, the HDD 84 stores data in the storage 15. The CPU 81 of the computer 80 reads these programs from the recording medium 88, and executes these programs. In another example, the CPU 81 of the computer 80 may acquire these programs from another device via the network N.

### 7. OTHERS

Furthermore, among pieces of processing described in the above-described embodiment, all or a part of the processing described as being automatically performed can be performed manually, or all or a part of the processing described as being manually performed can be performed automatically by a known method. In addition, the processing procedure, the specific names, and the information including various types of data and parameters illustrated in the above document and the drawings can be optionally changed unless otherwise specified. For example, the various types of information in each figure are not limited to the illustrated information.

Furthermore, each component of each device illustrated is functionally conceptual, and is not necessarily required to be physically configured as illustrated. That is, a specific form of distribution/integration of each device is not limited to the illustrated form. All or a part thereof can be functionally or physically distributed/integrated in any unit in accordance with various loads, use conditions, and the like.

For example, the above-described information processing terminal 1 may be implemented by a terminal device and a server computer, or may be implemented by a plurality of server computers. The configuration of the information processing terminal 1 can be flexibly changed by, for example, calling and implementing an external platform and the like by using an API and network computing depending on a function.

Furthermore, the embodiment and variations thereof described above can be appropriately combined within a range in which the processing contents do not contradict each other.

### 8. EFFECTS

As described above, the information processing terminal 1 according to the embodiment is an example of an information processing apparatus, and includes the receiver 20, the identification unit 21, the determination unit 22, the parameter value acquisition unit 30, the service information acquisition unit 31, and the provision unit 25. The receiver 20 receives input information including information on service from the user U. The identification unit 21 identifies the type of service and values of one or more parameters among a plurality of parameters used for providing the service of the type based on the input information received by the receiver 20. The determination unit 22 determines an unidentified parameter, which is a parameter having an unidentified value, among a plurality of parameters. The parameter value acquisition unit 30 acquires the value of the unidentified parameter determined by the determination unit 22. The service information acquisition unit 31 acquires information on service based on values of a plurality of parameters including values of one or more parameters and a value of an unidentified parameter. The provision unit 25 provides information on service acquired by the service information acquisition unit 31 to the user U. This enables the information processing terminal 1 to appropriately acquire information for enhancing the accuracy of response contents corresponding to the input information from the user U.

Furthermore, the parameter value acquisition unit 30 includes the output processor 40 and the acquisition processor 41. The output processor 40 outputs a message for inquiring of the user U the value of the unidentified parameter. The acquisition processor 41 acquires the value of the unidentified parameter input by the user in response to the message. This enables the information processing terminal 1 to appropriately acquire information for enhancing the accuracy of response contents corresponding to the input information from the user U.

Furthermore, the receiver 20 receives input information including a message regarding service input by the user U in a chat room as information on the service. The parameter value acquisition unit 30 acquires the value of the unidentified parameter from a history of messages in the chat room. This enables the information processing terminal 1 to appropriately acquire information for enhancing the accuracy of response contents corresponding to the input information from the user U.

Furthermore, when the unidentified parameter is set as a parameter that can be estimated, the information processing terminal 1 includes the estimator 24 that estimates the value of the unidentified parameter, and the parameter value acquisition unit 30 acquires the value of the unidentified parameter estimated by the estimator 24. This enables the information processing terminal 1 to appropriately acquire information for enhancing the accuracy of response contents corresponding to the input information from the user U.

Furthermore, when the acquisition processor 41 does not acquire the value of the unidentified parameter, the information processing terminal 1 includes the estimator 24 that estimates the value of the unidentified parameter, and the parameter value acquisition unit 30 acquires the value of the unidentified parameter estimated by the estimator 24. This enables the information processing terminal 1 to appropriately acquire information for enhancing the accuracy of response contents corresponding to the input information from the user U.

Furthermore, the estimator 24 estimates the value of the unidentified parameter based on the attribute of the user U. This enables the information processing terminal 1 to appropriately acquire information for enhancing the accuracy of response contents corresponding to the input information from the user U.

Furthermore, the receiver 20 receives input information including a message regarding service input by the user U in the chat room as information on the service. The estimator 24 estimates the value of the unidentified parameter based on a history of conversations in the chat room. This enables the information processing terminal 1 to appropriately acquire information for enhancing the accuracy of response contents corresponding to the input information from the user U.

Furthermore, the receiver 20 receives input information including a message regarding service input by the user U in the chat room as information on the service. The estimator 24 estimates the value of the unidentified parameter based on a history of conversations between a plurality of users including the user U in another chat room different from the chat room. This enables the information processing terminal 1 to appropriately acquire information for enhancing the accuracy of response contents corresponding to the input information from the user U.

Furthermore, the identification unit 21 inputs, to the generative AI, information including input information and information for making an instruction to identify values of a plurality of parameters. The identification unit 21 causes the generative AI to identify the type of service and the values of one or more parameters. This enables the information processing terminal 1 to appropriately acquire information for enhancing the accuracy of response contents corresponding to the input information from the user U.

Furthermore, the plurality of parameters includes a parameter necessary for providing service of the type identified by the identification unit 21. This enables the information processing terminal 1 to appropriately acquire information for enhancing the accuracy of response contents corresponding to the input information from the user U.

Although the embodiment of the present application has been described in detail above with reference to the drawings, this is merely an example. The present invention can be implemented in other forms in which various variations and improvements have been made based on the knowledge of those skilled in the art, including the aspects described in the column of the disclosure of the invention.

Furthermore, the “section”, “module”, and “unit” described above can be replaced with an “instrument” and a “circuit”. For example, an acquisition unit can be replaced with an acquisition instrument or an acquisition circuit.

According to one aspect of an embodiment, an effect of appropriately acquiring information for enhancing the accuracy of response contents corresponding to input information from a user can be exhibited.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a receiver that receives input information including information on service from a user;
an identification unit that identifies a type of the service and values of one or more parameters among a plurality of parameters used for providing the service of the type based on the input information received by the receiver;
a determination unit that determines an unidentified parameter, which is a parameter having a value that is unidentified, among the plurality of parameters;
a parameter value acquisition unit that acquires the value of the unidentified parameter determined by the determination unit;
a service information acquisition unit that acquires information on the service based on values of the plurality of parameters including the values of one or more parameters and the value of the unidentified parameter; and
a provision unit that provides, to the user, the information on the service acquired by the service information acquisition unit.

2. The information processing apparatus according to claim 1,
wherein the parameter value acquisition unit includes:
an output processor that outputs a message for inquiring of the user the value of the unidentified parameter; and
an acquisition processor that acquires the value of the unidentified parameter input by the user in response to the message.

3. The information processing apparatus according to claim 1,
wherein the receiver
receives the input information including a message regarding the service input by the user in a chat room as information on the service, and
the parameter value acquisition unit
acquires the value of the unidentified parameter from a history of a message in the chat room.

4. The information processing apparatus according to claim 1, further comprising
an estimator that estimates the value of the unidentified parameter when the unidentified parameter is set as a parameter that is allowed to be estimated,
wherein the parameter value acquisition unit
acquires the value of the unidentified parameter estimated by the estimator.

5. The information processing apparatus according to claim 2, further comprising
an estimator that estimates the value of the unidentified parameter when the acquisition processor does not acquire the value of the unidentified parameter,
wherein the parameter value acquisition unit
acquires the value of the unidentified parameter estimated by the estimator.

6. The information processing apparatus according to claim 4,
wherein the estimator
estimates the value of the unidentified parameter based on an attribute of the user.

7. The information processing apparatus according to claim 4,
wherein the receiver
receives the input information including a message regarding the service input by the user in a chat room as information on the service, and
the estimator
estimates the value of the unidentified parameter based on a conversation history in the chat room.

8. The information processing apparatus according to claim 4,
wherein the receiver
receives the input information including a message regarding the service input by the user in a chat room as information on the service, and
the estimator
estimates the value of the unidentified parameter based on a history of conversations between a plurality of users including the user in another chat room different from the chat room.

9. The information processing apparatus according to claim 1,
wherein the identification unit
inputs, to generative AI, information including the input information and information for making an instruction to identify the type of the service and the values of the plurality of parameters, and causes the generative AI to identify the type of the service and the values of one or more parameters.

10. The information processing apparatus according to claim 1,
wherein the plurality of parameters
includes a parameter necessary for providing the service of the type identified by the identification unit.

11. An information processing method to be executed by a computer, comprising:
receiving input information including information on service from a user;
identifying a type of the service and values of one or more parameters among a plurality of parameters used for providing the service of the type based on the input information received in the receiving;
determining an unidentified parameter, which is a parameter having a value that is unidentified, among the plurality of parameters;
acquiring the value of the unidentified parameter determined in the determining;
acquiring information on the service based on values of the plurality of parameters including the values of one or more parameters and the value of the unidentified parameter; and
providing, to the user, the information on the service acquired in the acquiring.

12. A non-transitory computer readable storage medium having stored therein an information processing program causing a computer to execute a process, the process comprising:
receiving input information including information on service from a user;
identifying a type of the service and values of one or more parameters among a plurality of parameters used for providing the service of the type based on the input information received in the receiving;
determining an unidentified parameter, which is a parameter having a value that is unidentified, among the plurality of parameters;
acquiring the value of the unidentified parameter determined in the determining;
acquiring information on the service based on values of the plurality of parameters including the values of one or more parameters and the value of the unidentified parameter; and
providing, to the user, the information on the service acquired in the acquiring.
